(19) United States
(12) Patent Application Publication
(10) Pub. No.: US 2017/0142119 A1
(43) Pub. Date: May 18, 2017

(54) METHOD FOR CREATING GROUP USER PROFILE, ELECTRONIC DEVICE, AND NON-TRANSITORY COMPUTER-READABLE STORAGE MEDIUM

(71) Applicants: LE HOLDINGS (BEIJING) CO., LTD., Beijing (CN); LECLOUD COMPUTING CO., LTD., Beijing (CN)

(72) Inventor: Youming Zhang, Beijing (CN)

(21) Appl. No.: 15/248,656

(22) Filed: Aug. 26, 2016

Related U.S. Application Data
(63) Continuation of application No. PCT/CN2016/083164, filed on May 24, 2016.

(30) Foreign Application Priority Data
Nov. 12, 2015 (CN) 201510772095.3

(51) Int. Cl. H04L 29/06

(52) U.S. Cl. CPC H04L 63/102; H04L 63/1408; H04L 63/1425

(57) ABSTRACT

Techniques are disclosed for creating a group user profile to improve group user profiling accuracy, including: detecting behaviors of each user in a target user group based on a label-attribute-weight library including labels, attributes under the labels, and reference attribute weights, and assigning each user with corresponding labels; determining, by referring to the label-attribute-weight library, attribute weights of attributes under labels for each user in the target user group, weight-averaging the attribute weights based on types of the attributes, and determining the attribute weights of various attributes of the target user group; and creating a group user profile of the target user group based on the determined attribute weights of various attributes of the target user group. The disclosure also provides a system for creating a group user profile.

### CROSS REFERENCE TO RELATED APPLICATIONS

This application is a continuation of International Application No. PCT/CN 2016/083164, filed on May 24, 2016, which is based upon and claims priority to Chinese Patent Application No. 201510772095.3, filed on Nov. 12, 2015, the entire contents of each of which are incorporated herein by reference.

### TECHNICAL FIELD

The disclosure relates to the technical field of user profiles and, more particularly, to a method for creating a group user profile and an electronic device.

### BACKGROUND

As the Internet has gradually stepped into the big data era, for enterprises, all behaviors of consumers seem to be “visualized.” As a result, the enterprises are focusing on how to use big data to offer accurate marketing services and identify potential commercial values. Thus, the concept of a “user profile” is brought up.

Big data allows enterprises to acquire broader user feedback information via the Internet conveniently to provide a sufficient database for accurate and rapid analysis of business information, such as user behaviors, consumption habits, and the like. With the deep understanding of people, the concept of a user profile is formed. It represents an abstraction of all information of a user, and can be seen as the foundation for the enterprises to apply big data.

A user profile, namely, labeled user information, is a panoramic commercial picture perfectly abstracted for a user after enterprises collect and analyze main information, such as social attributes, habits, and behaviors of the user, and can be seen as a basic mode for the enterprises to apply big data.

The user profile may be classified as an individual user profile or a group user profile. The former is mainly used for personalized customization, while the latter is used to categorize user groups. At present, all group user profiles are based on individual user profiles. That is, an individual user profile (in which values of all attributes of each user are determined) is created first, and then a group user profile (in which ratios of attribute values among all attributes are counted) is created.

Several common jargons used in the fields of user profiles include attribute, attribute value, and attribute weight, which are frequently used in group user profiling. An attribute represents a dimension required to be counted in user profiling, such as male and female in gender, juvenile, youth, middle age and old age in age, and various categorizations of income level (e.g., poor, low, medium and wealthy, etc.). In an individual user profile, an attribute weight is interpreted as a possibility. For example, if the attribute weight of male to female is 0.8:0.2, it can be interpreted that the possibility that the user may be a male is 80%, and the possibility that the user may be a female is 20%. However, in a group user profile, it can be interpreted that 80% of users in a counted group are male, and 20% of users in the counted group are female.

Conventionally, there are two main types of individual user profiling. In one method, a user profile is directly created based on user registration information. In the other method, a user's profile is created by personnel according to his/her personal experience to analyze all labels.

The first individual user profiling method has disadvantages. Specifically, since current access of many websites/media does not require registration in advance, these websites/media are not clear about the attributes of users. In addition, some users are reluctant to register user information. And even if the users do register information, it is difficult to ensure the accuracy of the registered information (such as information related to user privacy, time factors, and the like). Thus, it is difficult to obtain an accurate user profile.

The second individual user profiling method also has disadvantages. The obtained user profiles may differ greatly due to excessive dependence on individual factors of the personnel. Furthermore, the label timeliness is not taken into consideration. As a result, the obtained user profiles are inaccurate.

As a group user profile is established based on individual user profiles obtained in a conventional manner, errors of the individual user profiles, when counted into the group user profile, will be superimposed and enlarged. This results in poor accuracy of the group user profile.

### SUMMARY

The application provides a method for creating a group user profile and an electronic device aiming to solve the technical problem that group user profiling regarding inaccuracies due to discrepancies in individual profiles caused by individual differences during profiling of users.

In an embodiment, a method is provided for creating a group user profile, which includes: detecting behaviors of each user in a target user group based on a label-attribute-weight library including labels, attributes under the labels, and reference attribute weights, and assigning each user corresponding labels; determining attribute weights of attributes under labels for each user in the target user group by referring to the label-attribute-weight library, conducting weight-averaging operation on the attribute weights based on types of the attributes, and determining the attribute weights of various attributes of the target user group; and obtaining a group user profile of the target user group based on the determined attribute weights of various attributes of the target user group.

In another embodiment, an electronic device is provided, which includes at least one processor and a memory communicably connected with the at least one processor configured to store instructions thereon executable by the at least one processor, wherein execution of the instructions by the at least one processor causes the at least one processor to execute the method for creating a group user profile mentioned above.

In yet another embodiment a non-transitory computer-readable storage medium is provided storing executable instructions that, when executed by an electronic device, cause the electronic device to execute the method for creating a group user profile mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows a flow chart of a method for creating a group user profile according to an embodiment of the disclosure;

FIG. 2 shows a detailed execution chart of a preferred embodiment of step S102 of the method for creating a group user profile shown in FIG. 1;

FIG. 3 is a schematic view of a system for creating a group user profile according to an embodiment of the disclosure;

FIG. 4 shows an architecture for implementing the method and system for creating a group user profile according to the embodiments of the disclosure; and

FIG. 5 is a schematic view of an electronic device or server according to embodiments of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but do not include all possible embodiments. Based on the embodiments of the disclosure, other embodiments obtained by the ordinary skill in the art without undue experimentation are within the scope of the disclosure.

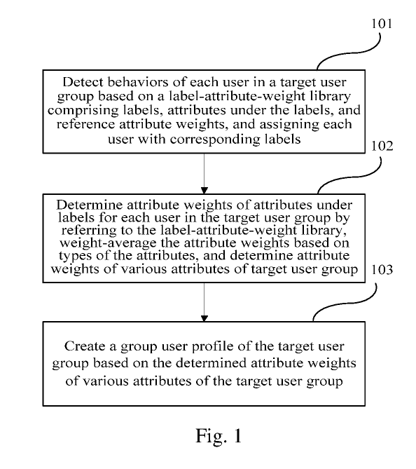

FIG. 1 shows a flow chart of a method for creating a group user profile according to an embodiment of the disclosure. In an embodiment, the method includes:

step S101: detecting behaviors of each user in a target user group by a user profiling server based on a label-attribute-weight library including labels, attributes under the labels, and reference attribute weights, and assigning each user corresponding labels;

step S102: determining by the user profiling server attribute weights of attributes under labels for each user in the target user group by referring to the label-attribute-weight library, conducting a weight-averaging for the attribute weights based on types of the attributes, and determining by the user profiling server the attribute weights of various attributes of the target user group; and

step S103: obtaining a group user profile of the target user group by the user profiling server based on the determined attribute weights of various attributes of the target user group.

In the method for creating a group user profile provided by the embodiments of the disclosure, a method including the following steps is proposed, which includes: establishing a label-attribute-weight library, querying and matching with the label-attribute-weight library, determining the attribute weights of various attributes of the target user group, and finally obtaining a group user profile of the target user group based on the determined attribute weights of various attributes of the target user group. The reference attribute weights in the label-attribute-weight library refer to averaged label-attribute-weights based on common people. By applying the reference attribute weights to the method for creating a group user profile, interference of individual user profiling errors to group user profiling is reduced, and the group user profiling accuracy can be improved.

In an embodiment, before detecting behaviors of each user in a target user group and assigning the user with corresponding labels, the method further includes establishing the label-attribute-weight library, which may include the following sub-steps:
selecting a reference user group associated with the target user group
assigning each user corresponding labels, by a user profiling server, based on behaviors of each user in the reference user group;
determining, by the user profiling server, attribute weights of attributes for each user in the reference user group based on the labels for each user in the reference user group;
endowing, by the user profiling server, labels corresponding to attributes with the attribute weights of the attributes for each user in the reference user group;
conducting a weight-averaging, by the user profiling server, of the attribute weights for all the users in the reference user group based on types of the labels, and determining, by the user profiling server, the reference attribute weights of various attributes under each label of the reference user group; and
establishing, by the user profiling server, the label-attribute-weight library based on the labels, the attributes under the labels and the reference attribute weights.

The reference attribute weights in the label-attribute-weight library obtained in this manner therefore refer to averaged label-attribute-weights based on common people. By applying the reference attribute weights to the method for creating a group user profile, interference of individual user profiling errors to group user profiling is reduced, and the group user profiling accuracy is improved.

In an embodiment of the disclosure, establishing the label-attribute-weight library may include determining attribute weights of attributes for each user in the reference user group based on historic performance of each user in the reference user group and a user attribute digging model. Common user attribute mining models may include any suitable number and/or type of models, such as, for example, an SVM model, a Bayesian model, a clustering model, a weight-averaging model, and other suitable algorithm models.

Traditionally, attributes of each individual user in a user group are derived, and then the determined individual user attributes are applied to the user group to obtain a group user profile. In the embodiments described herein, however, the user profiling server derives attribute weights for each user from historic performance of each user in the reference user group, which is a fuzzy processing on the user attributes. In addition, the user profiling server endows corresponding labels with the obtained attribute weights, so that the labels have higher reference value compared with the attributes, and the accuracy of the group user profile obtained based on the labels can be ensured.

As an example, a user profiling server interprets and classifies labels to acquire a matching attribute of each attribute. The classification can be realized, for example, via a keyword classification tool. A logic relationship between each attribute and the corresponding label exists to some extent, but it is not required that the attribute be derived from the matching label. For example, if a matching label is “Cosmetic,” it can be derived that a corresponding attribute is user gender, and it should be understood that an attribute weight corresponding to the attribute is a ratio of number of males to that of females.

In some alternate embodiments, a label-attribute-weight library includes a plurality of label-attribute-weight sub-libraries, and different label-attribute-weight sub-libraries correspond to attributes in different dimensions. For example, an age label-attribute-weight library corresponds to a user age dimension attribute, an income level label-attribute-weight library corresponds to a user income level dimension attribute, a consumption level label-attribute-weight library corresponds to a user consumption level dimension attribute, and a preference label-attribute-weight library corresponds to a user preference dimension attribute, and so on. Thus, a user profile is formed by user attributes in different dimensions.

It should be understood that an attribute may be formed by a matching keyword corresponding to a user behavior. That is, if a user performs operations, such as browsing, purchasing, paying attention to or collecting products, via web pages corresponding to all data sources, generation of log information is triggered. Accordingly, log information generation times may be used for indicating when the user performs such operations (e.g., browsing, purchasing, paying attention to or collecting the products). For the above user behaviors, product information or product classification information can be selected as matching keywords of user behaviors with user labels.

The various embodiments described herein provide a group user profiling technical scheme, which includes: assigning labels to all users (including users in a reference user group and a target user group) based on user behaviors; performing fuzzy derivation on one reference user in the reference group users based on empirical analysis to derive attribute weights of all attributes of the reference user; endowing all labels of the user with the attribute weights of all attributes; repeating the above processing until all reference users in the reference user group are subjected to the same processing; conducting weight-averaging for all attribute weights of each attribute to obtain a final attribute weight for establishing a label-attribute-weight library; placing all labels of a test user in the library to obtain weights of all attributes; then conducting a weight-averaging operation to obtain final weights of all attributes of the test user; repeating the above processing until all test users in the target user group are subjected to the same processing; and conducting a weight-averaging for weights of all attributes of all the test users to obtain a group user profile.

In an embodiment, after establishing the label-attribute-weight library based on the labels, the attributes under the labels and the reference attribute weights, the user profiling server periodically adds a number of users into the reference user group to modify and update the reference attribute weights.

The more reference users in the reference group, the more accurate the reference attribute weights will be. By using the user profiling server to periodically add a number of users into the reference user group to modify and update the reference attribute weights, the reference attribute weights are periodically corrected, and the real-time accuracy in group user profiling is further ensured.

As an improvement of the method shown in FIG. 1, a label-attribute-weight library may be queried. If no label matched with a label generated by the test user group is found in the label-attribute-weight library, the label (as well as an attribute and an attribute weight thereof) is added into the label-attribute-weight library. Thus, learning and updating of the label-attribute-weight library are realized. In one embodiment, all the attributes of the target user group can be referred to reference attribute weights of the reference user group, thus further improving the group user profiling accuracy.

In an embodiment, after the step S103 of the method shown in FIG. 1, the method further includes:
after completing the creation of the group user profile, pushing by a user profiling server personalized information to a user group based on the group user profile; and detecting by the user profiling server behaviors of the user group after the user group receives the personalized information to re-determine user attribute weights.

In the present embodiment, personalized information can be pushed to the user group based on the group user profile, and the attribute weights of the user group are re-determined based on the feedback of the user group to the pushed personalized information, thus realizing calibration of the attribute weights of the user group and the group user profile, and the type of information pushed to the user group can be changed based on user's feedback.

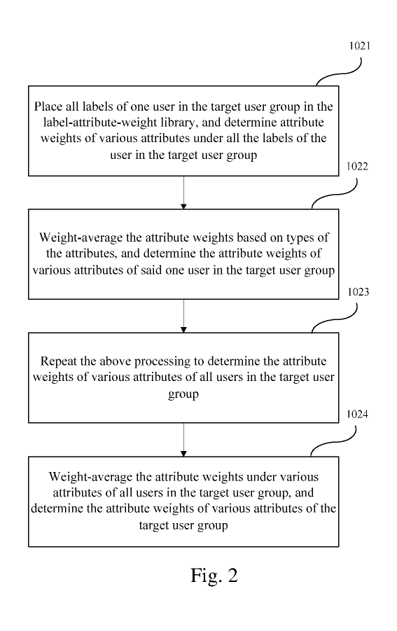

FIG. 2 shows a detailed execution chart of a preferred embodiment of step S102 of the method for creating a group user profile shown in FIG. 1. Referring to FIG. 2, as a variation of the method shown in FIG. 1, step S102 in FIG. 1 may include the following sub-steps: S1021: placing, by the user profiling server, all the labels of one user in the target user group in the label-attribute-weight library, and determining attribute weights of various attributes under all the labels of the user in the target user group;

S1022: carrying out a weight-averaging by the user profiling server of the attribute weights based on types of the attributes, and determining the attribute weights of various attributes of the one user in the target user group;

S1023: repeating the above processing to determine the attribute weights of various attributes of all users in the target user group by the user profiling server; and

S1024: carrying out a weight-averaging by the user profiling server of the attribute weights of various attributes of all users in the target user group, and determining the attribute weights of various attributes of the target user group.

In the present embodiment, on one hand, attributes of the target user group are determined using various labels of the target user group, thus improving the accuracy of the group user attributes. But on the other hand, by carrying out weight-averaging for the attribute weights of various attributes of all users in the target user group, the interference of individual user profiles to the group user profile can be avoided, and the group user profiling accuracy can be improved.

With respect to the specific execution, step S102 may include, for example:
placing all labels of one user in the target user group to the label-attribute-weight library, and determining, by a user profiling server, attribute weights of various attributes under all labels of the user, wherein all labels of one user in the target user group are put in the label-attribute-weight library, the user profiling server traverses the label-attribute-weight library using all the labels of said one user as a key to determine various attributes of all labels of said one user and attribute weights of various attributes;
carrying out a weight-averaging, by the user profiling server, the attribute weights according to the types of the attributes, and determining attribute weights of various attributes of said one user, wherein the user profiling server conducts weight-averaging for the attribute weights of all labels under the user age attribute of the user, the obtained average values are used as the attribute weights of the user under the user age attribute, and attribute weights of the one user under various attributes (for example, the user consumption level attribute and the user gender attribute) can be obtained by repeating the above processing;
determining, by the user profiling server attribute weights of various attributes of all users in the target user group by repeating the above processing, wherein the user profiling server performs the above processing on other users in the target user group to obtain the attribute weights of the target user group under various attributes, that is, the attribute weights of all users in the target user group under various attributes, such as the user age attribute, the user consumption level attribute, the user gender attribute and the like, can be obtained; and
carrying out a weight-averaging by the user profiling server of the attribute weights of all users in the target user group under various attributes, and determining attribute weights of the target user group under various attributes, wherein the user profiling server carries out a weight-averaging of the attribute weights of all users in the target user group under the user age attribute, the obtained average values being used as the attribute weights of the user group under the user age attribute, and attribute weights of the target user group under the user consumption level attribute, the user gender attribute and the like can be obtained by repeating the above processing.

With respect to the execution of step S103 as shown in FIG. 1, the user profiling server completes the creation of a group user profile of the target user group based on the determined attribute weights of various attributes of the target user group. As an example, the user profiling server applies the determined attribute weights of various attributes of the target user group to the attributes of the target user group. For example, if the attribute weight of the target user group under the gender dimension is 0.7:0.3 (Male:Female), it can be determined that 70% of users in the target user group are male and 30% of users in the target user group are female.

It should be understood that attribute weights are embodied in fuzzy processing of user attributes. That is, after the user profiling server determines the attribute weights of the user group, the fuzzy attribute weights are converted into clear population proportion about the user group attributes so as to complete a group user profile. The method for creating a group user profile provided by the embodiments of the disclosure is convenient to operate. Moreover, a better accuracy of the group user profiling can be obtained by applying the method described herein.

One advantage of the group user profiling scheme provided by the disclosure is that it is not necessary for a user profiling server to acquire accurate user registration information, or for the determination of individual user attributes in a user group to be very accurate or specific. Instead, all that is needed is to derive attribute weights of all individual users in the user group. For example, when deriving gender attributes of a user group, the user profiling server only needs to perform fuzzy derivation on gender of each individual user in the user group without conducting a precise determination of the gender (namely, male or female), of each individual user, and may just obtain an attribute weight (e.g., the possibility of being a male or female) of the individual user under the gender attribute.

Furthermore, when establishing a label-attribute-weight data library in the user profiling server, a reference user group associated with the target user group may be selected. In an embodiment, reference attribute weights of labels are updated along with increment of the number of reference users in the reference user group to enable the reference attribute weights to trend towards an averaged level based on common people, so that the reference attribute weights refer to averaged label-attribute-weights of the user group based on common people. By applying the reference attribute weights to group user profiling, interference of individual user profiling errors to group user profiling can be avoided.

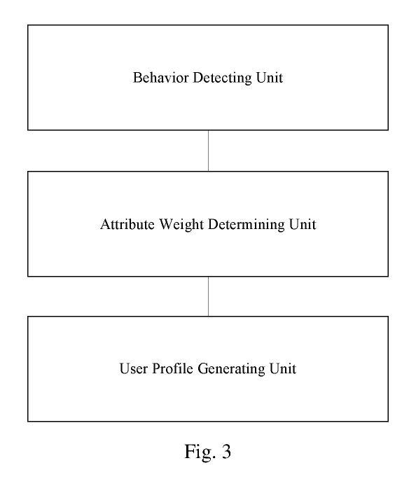

FIG. 3 is a schematic view of a system for creating a group user profile according to an embodiment of the disclosure. The method as shown in FIG. 1 may be realized by operating the following system as shown in FIG. 3. In other words, FIG. 3 represents a schematic structural view showing a system for creating a group user profile according to an embodiment of the disclosure, the system for creating a group user profile may include, for example, the following steps:
a behavior detecting unit configured to detect behaviors of each user in a target user group based on a label-attribute-weight library including labels, attributes under the labels, and reference attribute weights, and label each user with corresponding labels;
an attribute weight determining unit configured to determine attribute weights of attributes under labels, which are assigned by the behavior detecting unit to each user in the target user group by referring to the label-attribute-weight library, conduct a weight-averaging of the attribute weights based on types of the attributes, and determine the attribute weights of various attributes of the target user group; and
a user profile generating unit configured to create a group user profile of the target user group based on the attribute weights of various attributes of the target user group determined by the attribute weight determining unit.

In the system for creating a group user profile provided by the embodiments described herein, a scheme including the following steps may be implemented: establishing a label-attribute-weight library, querying and matching with the label-attribute-weight library, determining the attribute weights of various attributes of the target user group, and completing the generation of a group user profile of the target user group based on the determined attribute weights of various attributes of the target user group. The reference attribute weights in the label-attribute-weight library refer to averaged label-attribute-weights based on common people. By applying the reference attribute weights to the method for creating a group user profile, interference of individual user profiling errors to group user profiling can be reduced, and the group user profiling accuracy can be improved.

In various embodiments, the system for creating a group user profile described herein may be implemented as any suitable number and/or type of computing device. For example, the system may be implemented as a server or a server cluster, wherein each unit may be a separate server or server cluster. In such a case, interactions among the above units are implemented among the servers or the server clusters corresponding to all units, and the plurality of servers or server clusters constitute the system for creating a group user profile provided by the disclosure.

Specifically, the system for creating a group user profile formed by the plurality of servers or server clusters may include:
a behavior detecting server or server cluster configured to detect behaviors of each user in a target user group based on a label-attribute-weight library including labels, attributes under the labels and reference attribute weights, and assign each user with corresponding labels;
an attribute weight determining server or server cluster configured to determine attribute weights of attributes under labels which are assigned by the behavior detecting unit to each user in the target user group by referring to the label-attribute-weight library, conduct a weight-averaging of the attribute weights based on types of the attributes, and determine the attribute weights of various attributes of the target user group; and
a user profile generating server or server cluster configured to create a group user profile of the target user group based on the attribute weights of various attributes of the target user group determined by the attribute weight determining unit.

In an alternate embodiment, several units in the above multiple units together may form a server or server cluster. For example, the behavior detecting unit and the attribute weight determining unit together may constitute a first server or a first server cluster, and the user profile generating unit may constitute a second server or a second server cluster.

Here, interactions among the above units are implemented between the first and second servers or the first and second server clusters, and the first and second servers or the first and second server clusters constitute the system for creating a group user profile provided by the disclosure.

As an improvement of the system shown in FIG. 3, the system may further include a label-attribute-weight library establishing unit connected with the behavior detecting unit, the label-attribute-weight library establishing unit including:
a reference group user determining module configured to select a reference user group associated with the target user group;
a test label generating module configured to assign corresponding labels to each user based on behaviors of each user in the reference user group;
an attribute weight determining module configured to determine attribute weights of attributes for each user in the reference user group based on the labels for each user in the reference user group;
a weight label endowing module configured to endow labels corresponding to attributes with the attribute weights of the attributes for each user in the reference user group;
a label attribute determining module configured to conduct a weight-averaging of the attribute weights for all the users in the reference user group based on types of the labels, and determine the reference attribute weights of various attributes under each label of the reference user group; and
a label-attribute-weight library establishing module configured to establish the label-attribute-weight library based on the labels, the attributes under the labels and the reference attribute weights.

In various embodiments, the label-attribute-weight library establishing unit described herein may be implemented as any suitable number and/or type of computing device. For example, the label-attribute-weight library establishing unit may be implemented as a server or a server cluster, wherein each module may be a separate server or server cluster. In such a case, interactions among the above modules are implemented among the servers or the server clusters corresponding to all modules, and the plurality of servers or server clusters together may form the label-attribute-weight library establishing unit to constitute the system for creating a group user profile provided by the disclosure. In an alternate embodiment, several modules in the above multiple modules together may form a server or server cluster.

In accordance with the present embodiment, the reference attribute weights in the label-attribute-weight library may refer to averaged label-attribute-weights based on common people. By applying the reference attribute weights to the method for creating a group user profile, interference of individual user profiling errors to group user profiling can be reduced, and the group user profiling accuracy can be improved.

As a variation of the system of the disclosure, the label-attribute-weight library establishing unit may further include a weight model determining module configured to determine attribute weights of attributes for each user in the reference user group based on historic performance of each user in the reference user group and a user attribute mining model. Common user attribute mining models may include any suitable number and/or type of models, such as, for example, an SVM model, a Bayesian model, a clustering model, a weight-averaging model, and other suitable algorithm models.

In various embodiments, the label-attribute-weight library establishing unit in the embodiments may be a server or a server cluster, and the weight model determining module may be a separate server or server cluster. Thus, the separate server or server cluster may form the weight model determining module to constitute the label-attribute-weight library establishing unit, so as to form the system for creating a group user profile provided by the disclosure.

In the present embodiment, attribute weights for each user (which may be based on historic performance of each user in the reference user group) may be derived via fuzzy processing on the user attributes. In addition, the user profiling server may endow corresponding labels with the obtained attribute weights, so that the labels have higher reference value with respect to the attributes, and the group user profile obtained based on the labels is more accurate.

In an embodiment, the label-attribute-weight library establishing unit may further include an augment and modification module configured to (after establishing the label-attribute-weight library based on the labels, the attributes under the labels and the reference attribute weights), periodically add a number of users into the reference user group to modify and update the reference attribute weights.

In various embodiments, the label-attribute-weight library establishing unit in the present embodiment may be a server or a server cluster, whereas the augment and modification module may be a separate server or server cluster. Thus, the separate server or server cluster forming the augment and modification module may constitute the label-attribute-weight library establishing unit so as to form the system for creating a group user profile as discussed herein.

In the present embodiment, the more the reference users in the reference group there are, the accurate the reference attribute weights will be. By periodically adding a number of users into the reference user group to correct and update the reference attribute weights, the reference attribute weights are periodically corrected, and the group user profiling accuracy is further ensured.

As an alternate embodiment, the system may further include an information pushing unit connected with the user profiling generating unit, and configured to (after creating the group user profile), push personalized information to a user group based on the group user profile, and detect behaviors of the user group after the user group receives the personalized information to re-determine user attribute weights.

In various embodiments, each of the information pushing unit and the user profile generating unit may be implemented as any suitable number and/or type of computing device. For example, each of the information pushing unit and the user profile generating unit may be implemented as a server or a server cluster. In such a case, interactions between the user profile generating unit and the information pushing unit are implemented between the servers or the server clusters corresponding to the units, and the server or server cluster forms the information pushing unit to constitute the system for creating a group user profile provided by the disclosure.

In the present embodiment, the personalized information is pushed to the user group based on the group user profile, and the attribute weights of the user group are re-determined based on the feedback of the user group to the pushed personalized information, so that the attribute weights of the user group and the group user profile can be calibrated, and the type of information pushed to the user group can be changed based on the user's feedback.

In an alternate embodiment, the attribute weight determining unit shown in FIG. 3 may include, for example:
an individual weight determining module configured to place all the labels of one user in the target user group in the label-attribute-weight library, and determine attribute weights of various attributes under all the labels of said one user in the target user group;
an individual weight balancing module configured to conduct a weight-averaging operation on the attribute weights based on types of the attributes, and determine the attribute weights of various attributes of said one user in the target user group;
a group weight determining module configured to repeatedly invoke the individual weight determining module and the individual weight balancing module, and repeat the above processing to determine the attribute weights of various attributes of all users in the target user group; and
a group weight balancing module configured to conduct a weight-averaging operation on the attribute weights under various attributes of all users in the target user group, and determine the attribute weights of various attributes of the target user group.

In various embodiments, the attribute weight determining unit may be implemented as any suitable number and/or type of computing device. For example, the attribute weight determining unit may be implemented as a server or a server cluster, and each module may be a separate server or server cluster. In such a case, interaction among the above modules may be that among the servers or the server clusters corresponding to all modules, and the plurality of servers or server clusters together may form the attribute weight determining unit to constitute the system for creating a group user profile provided by the disclosure.

In an alternate embodiment, several modules in the above multiple modules together may form a server or server cluster.

In the present embodiment, on one hand, attributes of the target user group are determined with various labels of the target user group, thus improving the accuracy of the group user attributes. But on the other hand, by conducting the weight-averaging of the attribute weights under various attributes of all users in the target user group, the interference of individual user profiles to the group user profile can be avoided, and the group user profiling accuracy can be improved.

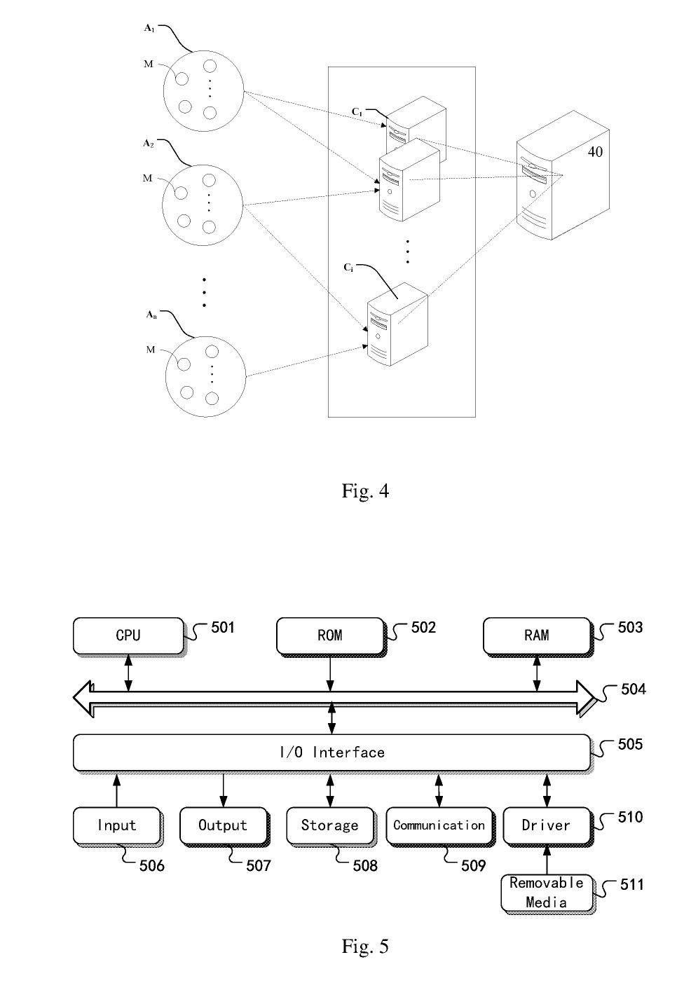

FIG. 4 shows an architecture for implementing the method and system for creating a group user profile according to the embodiments of the disclosure. For example, the architecture shown in FIG. 4 includes a user profiling server 40, any suitable number n of group users A1 to An, and any suitable number i of access servers C1 to Ci. In the architecture, after the access servers C1 to Ci complete response to access requests sent by any suitable number M of individual users to be drawn into the group users A1 to An via a client (e.g., an intelligent terminal), user profiling server 40 carries out the method for creating a group user profile as shown in FIG. 1 based on cache information of the server access requests of the group users A1 to An in the access servers C1 to Ci to acquire a relatively accurate group user profile of the group users A1 to An.

An embodiment of the present application provides a non-transitory computer-readable storage medium configured to store thereon executable instructions that, when executed by an electronic device, cause the electronic device to execute the method for creating a group user profile mentioned above.

FIG. 5 is a schematic view of an electronic device or server according to embodiments of the disclosure. As shown in FIG. 5, the device or server may include a processor like a central processing unit (CPU) 501, which can perform various appropriate actions and processing according to a program stored in a read-only memory (ROM) 502 or a program loaded to a random access memory (RAM) 503 from a storage part 508. Various programs and/or data required during operation of the system may also be stored in RAM 503. CPU 501, ROM 502 and RAM 503 may be connected with one another via a bus 504. An Input/output (I/O) interface 505 may also be connected to the bus 504.

Components connected to the Input/output (I/O) interface 505 may include, for example, an input part 506 that may include, for example, a keyboard, a mouse, and the like, an output part 507 that may include, for example, a cathode ray tube (CRT), a liquid crystal display (LCD), and the like, a storage part 508 that may include, for example, a hard disk, and the like, and a communication part 509 of network interface cards that may include, for example, a LAN card, a modem, etc. Communication part 509 may perform communication processing via a network such as the Internet. A driver 510 may be connected to the Input/output (I/O) interface 505 as needed to ensure proper operation. A removable medium 511 such as a magnetic disk, an optical disk, a magneto-optical disk, a semiconductor memory, etc., may be installed on the driver 510 as required so as to enable a computer program to read out from the removable medium to be installed into the storage part 508 according to the needs.

Particularly, according to the embodiments of the disclosure, the steps described in the above reference flow chart can be implemented as a computer program. For example, the embodiments of the disclosure include a computer program product including a computer program which is tangibly contained in a machine-readable medium, and the computer program includes a program code for performing the method as shown in the flow chart. In accordance with such embodiments, the computer program can be downloaded and installed from the network via the communication part 509, and/or can be installed from the removable medium 511.

In one aspect of application of the disclosure, the system for creating a group user profile provided by the embodiments of the disclosure can be embedded in a website server as a functional element. In another aspect of application of the disclosure, the system for creating a group user profile provided by the embodiments of the disclosure can be also embedded in a cloud server connected between the website server and a user terminal.

It should be noted that, embodiments of the present application and the technical features involved therein may be combined with each other in case they are not conflict with each other. Further, terms like “include”, “including”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

The above functional modules and units discussed in the embodiments of the disclosure can be implemented, for example, through software in conjunction with general-purpose hardware, or directly via hardware implementations (e.g., via a hardware processor).

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for creating a group user profile via an electronic device, comprising:
detecting behaviors of each user in a target user group based on a label-attribute-weight library that includes labels, attributes under the labels, and reference attribute weights, and assigning each user with corresponding labels;
determining the attribute weights of attributes under labels for each user of the target user group by referring to the label-attribute-weight library;
conducting a weight-averaging operation on the attribute weights based on types of the attributes;
determining the attribute weights of attributes of the target user group; and
creating the group user profile of the target user group based on the determined attribute weights of attributes of the target user group.

2. The method of claim 1, further comprising:
before the act of detecting behaviors of each user in a target user group, establishing the label-attribute-weight library by:
selecting a reference user group associated with the target user group;
assigning each user with corresponding labels based on behaviors of each user in the reference user group;
determining attribute weights of attributes for each user in the reference user group based on the labels for each user in the reference user group;
endowing labels corresponding to attributes with the attribute weights of the attributes for each user in the reference user group;
conducting weight-averaging of the attribute weights for each of the users in the reference user group based on types of the labels;
determining the reference attribute weights of attributes under each label of the reference user group; and
establishing the label-attribute-weight library based on the labels, the attributes under the labels, and the reference attribute weights.

3. The method of claim 1, wherein the act of determining the attribute weights of attributes under labels for each user of the target user group by referring to the label-attribute-weight library, conducting the weight-averaging operation on the attribute weights based on types of the attributes, and determining the attribute weights of attributes of the target user group comprises:
placing each of the labels of one user of the target user group in the label-attribute-weight library, and determining attribute weights of attributes under all the labels of the user in the target user group;
conducting weight-averaging of the attribute weights based on types of the attributes;
determining the attribute weights of the attributes of the one user in the target user group;
repeating the above processing to determine the attribute weights of attributes of each of the users in the target user group; and
conducting weight-averaging of the attribute weights under the attributes of each of the users in the target user group to determine the attribute weights of attributes of the target user group.

4. The method of claim 2, further comprising:
after the act of establishing the label-attribute-weight library based on the labels, the attributes under the labels, and the reference attribute weights, periodically adding users to the reference user group to correct and renew the reference attribute weights.

5. The method of claim 2, wherein the act of determining attribute weights of attributes for each user in the reference user group comprises:
determining attribute weights of attributes for each user in the reference user group according to a historic performance of each user in the reference user group and a user attribute digging model.

6. An electronic device, comprising:
at least one processor; and
a memory communicably connected with the at least one processor configured to store instructions executable by the at least one processor, wherein execution of the instructions by the at least one processor causes the at least one processor to:
detect behaviors of each user in a target user group based on a label-attribute-weight library that includes labels, attributes under the labels, and reference attribute weights, and assign each user with corresponding labels;
determine the attribute weights of attributes under labels for each user in the target user group by referring to the label-attribute-weight library;
conduct a weight-averaging of the attribute weights based on types of the attributes;
determine the attribute weights of attributes of the target user group; and
create the group user profile of the target user group based on the determined attribute weights of attributes of the target user group.

7. The electronic device of claim 6, wherein execution of the instructions by the at least one processor further causes the at least one processor to:
select a reference user group associated with the target user group;
assign corresponding labels to each user in the reference user group based on their behaviors;
endow labels corresponding to attributes with the attribute weights of the attributes for each user in the reference user group;
conduct a weight-average of the attribute weights for each of the users in the reference user group based on types of the labels;
determine the reference attribute weights of attributes under each label of the reference user group; and
establish the label-attribute-weight library based on the labels, the attributes under the labels, and the reference attribute weights.

8. The electronic device of claim 6, wherein execution of the instructions by the at least one processor further causes the at least one processor to:
place each of the labels of one user in the target user group in the label-attribute-weight library, and determine attribute weights of attributes under each of the labels of the user in the target user group;
conduct weight-averaging of the attribute weights based on types of the attributes;
determine the attribute weights of attributes of said one user in the target user group;
repeat the above processing to determine the attribute weights of attributes of each of the users in the target user group; and
conduct weight-averaging of the attribute weights under attributes of each of the users in the target user group, and determine the attribute weights of attributes of the target user group.

9. The electronic device of claim 7, wherein execution of the instructions by the at least one processor further causes the at least one processor to:
after establishing the label-attribute-weight library based on the labels, the attributes under the labels, and the reference attribute weights, periodically add users to the reference user group to modify and update the reference attribute weights.

10. The electronic device of claim 7, wherein execution of the instructions by the at least one processor further causes the at least one processor to:
determine attribute weights of the attributes for each user in the reference user group based on a historic performance of each user in the reference user group and a user attribute digging model.

11. A non-transitory computer-readable storage medium storing executable instructions that, when executed by one or more processors associated with an electronic device, cause the electronic device to:
detect behaviors of each user in a target user group based on a label-attribute-weight library that includes labels, attributes under the labels, and reference attribute weights, and assign each user with corresponding labels;
determine the attribute weights of attributes under labels for each user in the target user group by referring to the label-attribute-weight library;
conduct a weight-averaging of the attribute weights based on types of the attributes;
determine the attribute weights of attributes of the target user group; and
create the group user profile of the target user group based on the determined attribute weights of attributes of the target user group.

12. The non-transitory computer-readable storage medium of claim 11, wherein execution of the instructions by the one or more processors further causes the electronic device to:
select a reference user group associated with the target user group;
assign corresponding labels to each user in the reference user group based on their behaviors;
endow labels corresponding to attributes with the attribute weights of the attributes for each user in the reference user group;
conduct weight-average of the attribute weights for each of the users in the reference user group based on types of the labels, and determine the reference attribute weights of attributes under each label of the reference user group; and
establish the label-attribute-weight library based on the labels, the attributes under the labels and the reference attribute weights.

13. The non-transitory computer-readable storage medium of claim 11, wherein execution of the instructions by the electronic device further causes the electronic device to:
put each of the labels of one user in the target user group in the label-attribute-weight library, and determine attribute weights of attributes under each of the labels of the user in the target user group;
conduct weight-averaging of the attribute weights based on types of the attributes, and determine the attribute weights of attributes of said one user in the target user group;
repeat the above processing to determine the attribute weights of attributes of each of the users in the target user group; and
conduct weight-averaging of the attribute weights under attributes of each of the users in the target user group, and determine the attribute weights of attributes of the target user group.

14. The non-transitory computer-readable storage medium of claim 11, wherein execution of the instructions by the electronic device further causes the electronic device to:
after establishing the label-attribute-weight library based on the labels, the attributes under the labels and the reference attribute weights, periodically add users into the reference user group to modify and update the reference attribute weights.

15. The non-transitory computer-readable storage medium of claim 11, wherein execution of the instructions by the electronic device further causes the electronic device to:
determine attribute weights of attributes for each user in the reference user group based on historic performance of each user in the reference user group and a user attribute digging model.
